(19) United States
(12) Patent Application Publication
(10) Pub. No.: US 2004/0051686 A1
(43) Pub. Date: Mar. 18, 2004

(54) Carry-on device having functions of both digital photographing and timing

(76) Inventor: Yuan-Sung Weng, Taipei (TW)

Correspondence Address: BACON & THOMAS, PLLC, 625 SLATERS LANE, FOURTH FLOOR, ALEXANDRIA, VA, 22314

(21) Appl. No.: 10/244,743

(22) Filed: Sep. 17, 2002

(51) Int. Cl. G09G 3/36

(52) U.S. Cl. 345/87

(57) ABSTRACT

The invention disclosed a carry-on device having functions of both digital photographing and timing, which is characterized in that a Super Twisted-Nematic liquid crystal display and a Twisted-Nematic liquid crystal display are used to display data and time, respectively, and two separate batteries are provided to power these two displays so as to achieve an effect of increasing the power efficiency.

### FIELD OF THE INVENTION

The present invention relates to a carry-on device having functions of both digital photographing and timing, especially to a carry-on device having functions of both digital photographing and timing with increased power efficiency.

### BACKGROUND ART

At present, the only manufacturer being available on put into market for a carry-on device having function of digital photographing and timing is the Casio Corporation of Japan. As disclosed in Japanese Patent Application 60-148263, such carry-on device, which can be switchable between a timing mode and a photographing mode, uses a single liquid crystal display to display time in timing mode and to display image in photographing mode and is supplied with a single battery. Thus, this single display must be supplied with power in either photographing mode or timing mode to display image or time. In order to display a frame with sufficient clearness so as to facilitate user of image observation, such display must have sufficient resolution and size, for example, a display on one of the Casio product has a Super Twisted-Nematic (STN) liquid crystal display of 14,400 pixels and 20 mm×20 mm. However, this display requires more electric power supply in comparison with a display originally only used for time displaying due to continuously display time even if no image display is performed. Therefore, such product has high power consumption and needs to replace battery frequently, for example, such a Casio product can only last for six months under timing mode that may cause inconvenience for user. However, practically we don't need a display of large size and high resolution like the one use for image displaying, instead a display of less power consumption (e.g., of smaller size and lower resolution) exclusively for time displaying is used to reduce the power consumption in timing mode and further reduce the entire power consumption of the display to extend the life of the battery. Furthermore, since only one battery is used to provide power supply, when the battery can no longer supply the electric power such product may lose its basic function of time displaying. Moreover, since the pre-stored electricity of the battery is limited, one can only use a 16 gray scale display instead of a color display (due to high power consumption) for image displaying to avoid the disadvantage of fast power consumption that might result in frequent battery replacement even when only timing mode is performed. Therefore, if two batteries are used to display for displaying image and time, only the function of photographing is lost even when exhaustion of the electricity occurred in the battery of the image display. The display for time displaying powered by another battery can still be functioning to maintain the fundamental function of time displaying, so that there is less constraint in the selection of display for image displaying.

### SUMMARY OF THE INVENTION

Therefore, an object of present invention is to provide a carry-on device having functions of both digital photographing and timing, which is capable of reducing power consumption while performing the function of timing.

Another object of present invention is to provide a carry-on device having functions of both digital photographing and timing, which is capable of increasing power efficiency.

Further object of present invention is to provide a carry-on device having functions of both digital photographing and timing, which is capable of making bi-directional signal transmissions with external devices.

Still further object of present invention is to provide a carry-on device having functions of both digital photographing and timing, which is capable of displaying data downloaded from external devices.

To achieve above objects, a carry-on device having functions of both digital photographing and timing is provided according to present invention, including a case, a circuit unit, a memory, an image sensing unit, a Super Twisted-Nematic liquid crystal display, a Twisted-Nematic liquid crystal display and two batteries. The case has a first wall, a second wall facing the first wall, and at least one third wall located between said first wall and the second wall to define a receiving space. The circuit unit is placed in the receiving space of the case and has a function of image processing, timing, and controlling of each member. Implanted on one of the third wall, the image sensing unit can generate image signals according to the control of the circuit unit and feed such signals into the circuit unit for further processing. Said Super Twisted-Nematic liquid crystal display is installed on the wall of the case and is electrically connected to the circuit unit, for displaying the processed image signals. The Twisted-Nematic liquid crystal display is installed on the wall of the case and is electrically connected to the circuit unit, for displaying time of the circuit unit, and the Twisted-Nematic liquid crystal display has a smaller size than that of the Super Twisted-Nematic liquid crystal display. The two batteries are used to supply electric power required by the Super Twisted-Nematic liquid crystal display and the Twisted-Nematic liquid crystal display as well as other corresponding member of said carry-on device.

### BRIEF DESCRIPTION OF DRAWIGNS

The above and other objects, features, and advantages of present invention will become more apparent from the detailed description in conjunction with the following drawings:

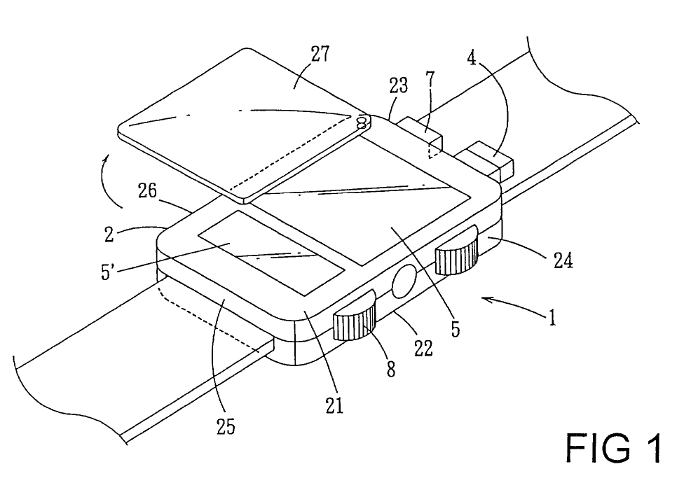

FIG. 1 is a schematic 3-D view of a carry-on device having functions of both digital photographing and timing in accordance with a preferred embodiment of present invention.

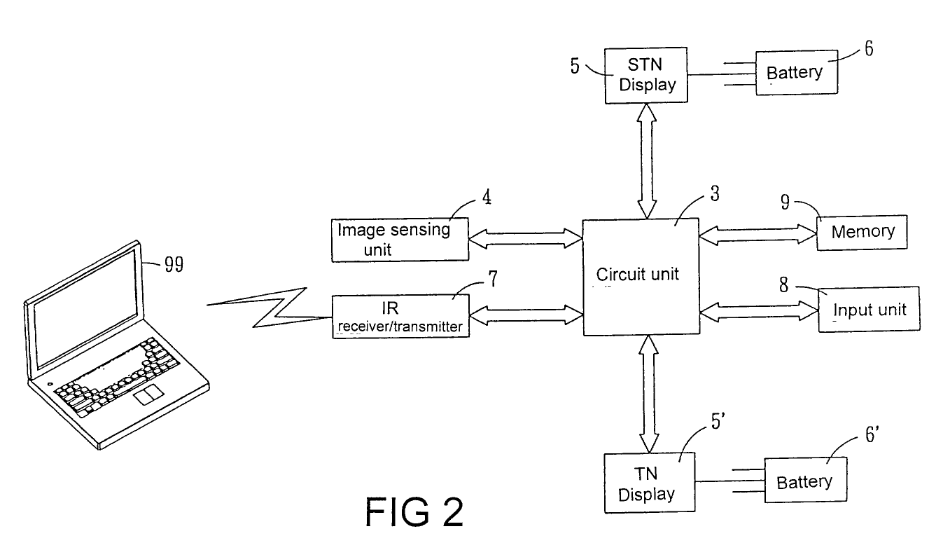

FIG. 2 is a block diagram showing a structure of the carry-on device of FIG. 1.

### DETAILED DESCRIPTION OF THE INVENTION

Referred to FIGS. 1 and 2, a description is made to a carry-on device 1 having functions of both digital photographing and timing in accordance with a preferred embodiment of present invention. The embodiment is a watch type carry-on device including a case 2, a circuit unit 3, a image sensing unit 4, a Super Twisted-Nematic (STN) liquid crystal display 5, a Twisted-Nematic (TN) liquid crystal display 5′, two batteries 6,6′, a radio receiver/transmitter 7, an input unit 8 and a memory 9.

The case 2 is a rectangular case having a first wall 21, a second wall 22 facing the first wall 21 and four third wall 23-26 located between said first wall 21 and said second wall 22 to define a receiving space. With these walls 21-26, the positioning and receiving of other members are provided. The first wall 21 is installed with a STN liquid crystal display 5 and a TN liquid crystal display 5′. In this embodiment, to facilitate the user of image observation, a convex lens 27 pivotally covering the STN liquid crystal display is mounted on the first wall 21 to achieve the effect of image magnification. Two batteries 6,6′ (not shown) are isntalled on the second wall 22. Further, the circuit unit 3 and the memory 9 are placed in the receiving space inside the case 2, the image sensing unit 4 and radio receiver/transmitter 7 are installed on one of the third wall 23, an input unit 8 is installed on another third wall 24. Although the previous description has specify the shape of case 2 and the location of each member 3-8 on the case, various modification can be made based on the need of the designer and are not limited to such an embodiment. For example, a TN liquid crystal display 5′ can also be installed on another third wall, so as to minimize the observation time as well as to reduce the area of the first wall.

The circuit unit 3 is electrically connected to the image sensing unit 4, the STN liquid crystal display 5, the TN liquid crystal display 5′, the batteries 6,6′, the radio receiver/transmitter 7, the input unit 8 and the memory 9. The circuit unit 3 has functions of data processing, timing, and controlling of each member 4, 5, 5′, 6, 6′, 7, 8 and 9.

Said image sensing unit 4 includes a complementary metal-oxide-semiconductor (hereinafter referred as CMOS) sensor and a camera lens. Thus, when the image sensing unit 4 functions under the command of said circuit unit 3, an external scene can be sharply projected onto said CMOS sensor via said camera lens to form an image signal of the electric signal to be fed into the circuit unit 3. Thereafter, the circuit unit 3 may conduct image processing to convert the electric signals into a displaying signals suitable to the STN liquid crystal display 5. Such displaying signals are then transmitted to the STN liquid crystal display to provide the user with the image taken during shuttering. The STN liquid crystal display 5 may display an image corresponding to the image signal of suitable STN specification received from and under the control of the circuit unit 3. The TN liquid crystal display 5′ may also display time received from the circuit unit 3 under the control of the circuit unit. In this embodiment, a TN liquid crystal display only consume less power than a STN liquid crystal display under the same condition (i.e., with same size and resolution), therefore a TN liquid crystal display is adapted for time displaying to reduce power consumption in timing mode. The size of time displaying TN liquid crystal display 5′ can be made smaller in comparison with the size of the data displaying STN liquid crystal display 5, thus, the power consumption of performing the timing mode can be efficiently reduced relative to the power consumption of performing the function of data displaying.

One of the two batteries 6 is used to supply power for members performing photographing such as part of circuit unit 3 used for data processing, memory 4, STN liquid crystal display 5, IR receiver/transmitter 7 and memory 9 in such carry-on device 1. Another battery 6′ is used to supply power for members performing time displaying such as remaining part of circuit unit (e.g., control and timing part of the circuit) 3 used for time displaying, TN liquid crystal display 5′ and input data 8 in such carry-on device 1. With this, one can easily achieve in this embodiment to independently supply power for timing mode and photographing mode. It is then possible to stop battery 6 from supplying power to the STN liquid crystal display 5 when no photographing is performed to effectively reduce power consumption and increase the power efficiency. Even if it consumes more electric power to perform photographing, the life of the timing mode is not affected due to a battery 6′ exclusively used for time displaying. Thus in comparison with prior carry-on device, this embodiment can effectively extend the life of timing mode (i.e. up to about 5 years in life). Also, the STN liquid crystal display 5 for photographing no longer need to take into account the life shortening of timing mode, a color STN liquid crystal display can also be adapted to achieve the effect of presenting color-frame.

The radio receiver/transmitter 7 is electrically connected to the circuit unit 3 for receiving/transmitting signals to achieve bi-directional signal transmission with external electronic devices. Further, as shown in FIG. 2, in this embodiment, the radio receiver/transmitter 7 is an IR receiver/transmitter and the electronic device 1 is a notebook personal computer 99 having function of infrared transmission. With such device, the image signal can be transmitted to this notebook personal computer 99 for image processing via the IR receiver/transmitter 7 before being sent back to the carry-on device 1 via said IR receiver/transmitter 7 again to be displayed on the STN liquid crystal display 5. After received a primary image processing from the circuit unit 3, the image signal can be transmitted to this notebook computer 99 for further image processing before being sent back to the carry-on device 1 via said IR receiver/transmitter 7. Therefore, it is possible to make the image frame displayed on said STN liquid crystal display 5 more vivid. Further, the carry-on device 1 of this embodiment can display on the STN liquid crystal display 5 the image signal or data directly downloaded from a notebook personal computer 99 via said IR receiver/transmitter 7 instead of that is formed by said image sensing unit 4. Furthermore, the image displayed on said STN liquid crystal display 5 is not limited to the image taken by said image sensing unit 4 but also can be an image signal provided with content of more variety, colorful and interesting by means the function of data transmission.

The input unit 8 has several control buttons and is electrically connected to circuit unit 3 for user to control the carry-on device 1, and the circuit unit 3 may control the action of each member in accordance with the variation of input signals from the input unit 8. With this, the user can use the input unit 8 to control whether or not to perform the switching of the carry-on device 1.

The memory 9 is used to store the image signal taken by said image sensing unit 4 or the image signal data downloaded from an external notebook personal computer 99. Thus, the user can view a desired image by using a the input unit 8 such as a transmission interface unit connected to the storage unit to control said circuit unit 3 and extract an image from said memory 9 at any desired time. As described above, since the carry-on device 1 of present invention uses a STN liquid crystal display 5 and a smaller TN liquid crystal display 5′ to display image and time, respectively, the power supply required for timing mode is effectively reduced in comparison with that of the prior art. It is then possible to simultaneously display image and time to achieve an effect of more convenience. Since the STN liquid crystal display 5 and the smaller sized TN liquid crystal display 5′ are powered with different batteries 6, 6′, respectively, the power supplied form the battery 6 to the STN liquid crystal display 5 can be cutoff so as to effectively reduce the entire power consumption and increase the power efficiency. Thus, the effective life of timing can be extended and it is possible to display color image with the STN liquid crystal display 5. Furthermore, in this embodiment, since the radio receiver/transmitter 7 has a function of bi-directional data transmission, the carry-on device 1 of the embodiment can use an external electronic device (e.g. notebook personal computer 99, personal digital assistant, etc.) to perform image processing and data downloading. It is then possible to display an image of higher vivid and more variety. Also, the user may use the memory 9 to store the image signal so as to view the image taken or downloaded from external devices at any time.

Therefore, the time display unit preferably posses its own independent power source to prevent the battery from being frequently replaced owing to large power consumption of the image and data displaying unit, and to prevent the time display unit from being iteratively adjusted due to the frequent battery replacement. Furthermore, there is no need to have a large size and a color display to show the time. Thus, the present invention provides a novel carryon device having functions of both digital photographing and timing, which employs two displays and discrete power sources, as well as commonly uses a same input unt for controlling these two displays, discrete power sources and relevant circuit units.

Above described are preferred embodiments of the invention but not intended to be the limit of the invention, for example the present invention is not limited to watch type but can be a pendant watch, which means various change and modification without departing from the claim must be considered as fall within the scope of the invention.

Description of Symbol

Numeral Descriptions

1 carry-on device

2 case

3 circuit unit

4 image sensor unit

5 STN liquid crystal display

5′ TN liquid crystal display

6 battery

6′ battery

7 radio receiver/transmitter

8 input unit

21 first wall

22 second wall

23-26 third walls

27 convex lens

99 notebook personal computer

What is claimed is:

1. A carry-on device having functions of both digital photographing and timing, comprising:
a case having a first wall, a second wall facing said first wall and at least one third wall located between said first wall and said second wall to define a receiving space;
a circuit unit placed in the receiving space of the case and has functions of data processing, timing, and action controlling of each member;
an image sensing unit installed on one of the third wall for generating image signals according to the control of said circuit unit and feed such signals into said circuit unit for further processing;
a Super Twisted-Nematic liquid crystal display installed on the wall of the case and is electrically connected to the circuit unit, for displaying data stored in the memory under the control of the circuit unit;
a Twisted-Nematic liquid crystal display installed on the wall of the case and is electrically connected to the circuit unit, for displaying time of the circuit unit, and said Twisted-Nematic liquid crystal display has a smaller size than the Super Twisted-Nematic liquid crystal display; and
two batteries for supplying electric power required by said Super Twisted-Nematic liquid crystal display and said Twisted-Nematic liquid crystal display as well as other corresponding members of said carry-on device.

2. The carry-on device having functions of both digital photographing and timing as set forth in claim 1, further comprises a convex lens covering on said Super Twisted-Nematic liquid crystal display for magnifying the displayed image.

3. The carry-on device having functions of both digital photographing and timing as set forth in claim 1, further comprises an input unit installed on the third wall of said case and is electrically connected to a circuit unit for inputting a control signal to said circuit unit, wherein said circuit unit may correspondingly control other members of said carry-on device in accordance with said control signal.

4. The carry-on device having functions of both digital photographing and timing as set forth in claim 1, wherein said circuit unit can stop said two batteries from supplied power to said Super Twisted-Nematic liquid crystal display when there is no data to be displayed.

5. The carry-on device having functions of both digital photographing and timing as set forth in claim 1, further comprises a memory for storing said image signals.

6. The carry-on device having functions of both digital photographing and timing as set forth in claim 1, further comprises a radio receiver/transmitter connected to said circuit unit for receiving and transmitting image signals of external radio waves.

7. The carry-on device having functions of both digital photographing and timing as set forth in claim 6, wherein said radio receiver/transmitter is an IR receiver/transmitter.

8. The carry-on device having functions of both digital photographing and timing as set forth in claim 6, wherein said radio receiver/transmitter is installed on one of the third wall of the case.

9. The carry-on device having functions of both digital photographing and timing as set forth in claim 8, wherein said radio receiver/transmitter is located on the same wall of the third wall as said image sensing unit.

10. The carry-on device having functions of both digital photographing and timing as set forth in claim 1, wherein said Twisted-Nematic liquid crystal display is insatalled on another third wall of the case.

11. The carry-on device having functions of both digital photographing and timing as set forth in claim 1, further comprises a transmission interface unit connected to said storage unit for transmitting image via the connection of said transmission interface unit to other devices, wherein said other devices includes personal computer (PC), personal digital assistant (PDA) and the like.
